(19) United States
(12) Patent Application Publication
(10) Pub. No.: US 2005/0179510 A1
(43) Pub. Date: Aug. 18, 2005

(54) Electromagnetic relay system

(75) Inventor: Kohei Iima, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: ASAHI DENSO CO., LTD.

(21) Appl. No.: 11/058,244

(22) Filed: Feb. 16, 2005

(30) Foreign Application Priority Data
Feb. 18, 2004 (JP) P. 2004-040696

(51) Int. Cl. H01H 51/22

(52) U.S. Cl. 335/126

(57) ABSTRACT

An electromagnetic relay system is constituted by containing an electromagnetic relay arranged in a case and including a coil, a movable contact and a plurality of fixed contacts, a positive terminal and a negative terminal formed to project from the case, and load terminals formed to project from the case and connectable to a motor. An electric current flowing in the motor is controlled by controlling an electric current flowing in the coil. A ground line extended from the coil is connected to the negative terminal via a coil spring in the case.

This application claims foreign priority based on Japanese patent application No. JP-2004-040696, filed on Feb. 18, 2004, the contents of which is incorporated herein by reference.

### BACKGROUND OF THE INVENTION

The present invention relates to an electromagnetic relay system for controlling an electric current flowing in a load by controlling an electric current flowing in a coil of a relay means.

An electromagnetic relay system of a related art, for example, an electromagnetic relay system for controlling an operation of a winch or the like mounted on an ATV (All Terrain Vehicle), is constituted by containing an electromagnetic relay comprising two coils and a plurality of fixed terminals in a substantially hermetically closed case made of a resin and including a plurality of terminals formed by being projected from the case. In the electromagnetic relay system, a motor as a drive source of the winch or the like regularly rotates when an electric current is flowed in one of the coils, and the motor reversely rotates when the electric current is flowed in the other of the coils.

Further, specifically, the electromagnetic relay system comprises a positive terminal and a negative terminal both connectable to a power source of a battery or the like arranged at the ATV and a load terminal connectable to the motor for driving the winch. The electromagnetic relay system further comprises control wirings extended from a change over switch separately arranged and connected to respectives of the coils of the respective electromagnetic relays. The electromagnetic relay system is constituted to be able to arbitrarily rotate regularly and reversely the motor by selectively making currents flow to the respectives of the coils at the respective electromagnetic relays via the control wirings.

Meanwhile, according to the above-described electromagnetic relay system of the related art, whereas one end of the coil constituting the electromagnetic relay is connected to the control wiring, a ground line extended from the coil is extended from the case to an external portion and a front end thereof is connected to the negative terminal. That is, according to the coil constituting the electromagnetic relay, when the electric current flows from the control wiring, the electric current reaches to the negative terminal via the ground line and is grounded therefrom.

However, since the above-described electromagnetic relay system of the related art is constituted by extending the ground line of the coil constituting the electromagnetic relay from the case to the external portion and connecting the ground line to the negative terminal and therefore, it is necessary to form a through hole for inserting the ground line through the case and it is necessary to fit a grommet or to fill a resin for waterproofing the through hole.

### SUMMARY OF THE INVENTION

The present invention has been carried out in view of such a situation and it is an object thereof to provide an electromagnetic relay system connecting a ground line of a coil constituting an electromagnetic relay to a negative terminal at an inner portion of the case and capable of promoting waterproof performance.

In order to achieve the object, an electromagnetic relay system according to a first aspect of the present invention comprises an electromagnetic relay arranged in a case and including a coil, a movable contact and a plurality of fixed contacts, a positive terminal and a negative terminal formed to project from the case and capable of being connected to a power source, and a load terminal formed to project from the case and connectable to a load, wherein an electric current flowing in the load is controlled by controlling an electric current flowing in the coil of the electromagnetic relay, and wherein a ground line extended from the coil is connected to the negative terminal in the case.

In addition to the electromagnetic relay system of the first aspect, in the electromagnetic relay system of a second aspect, the electromagnetic relay may be arranged with a board in the case and the ground lines extended from the respective coils may be connected to the negative terminal via the board.

In addition to the electromagnetic relay system of the second aspect, in the electromagnetic relay system of a third aspect, a spring made of a conductive material may interpose between the board and the negative terminal and the ground lines may be connected to the negative terminal via the spring.

Moreover, in addition to the electromagnetic relay system of any one of first to third aspects, in the electromagnetic relay system of a fourth aspect, the electromagnetic relay may comprise a multiple connected type electromagnetic relay arranged with a plurality of the coils in the case.

According to the first aspect of the present invention, the ground line of the coil constituting the electromagnetic relay is connected to the negative terminal at inside of the case and therefore, it is not necessary to provide a through hole for the ground line to the case and a waterproof performance of the electromagnetic relay system can be promoted.

According to the second aspect of the present invention, the ground lines extended from the coils of the electromagnetic relay are connected to the negative terminal via the board arranged in the case and therefore, wiring can be simplified and operability in fabricating the electromagnetic relay system can be promoted.

According to the third aspect of the present invention, the ground lines are connected to the negative terminal via the conductive spring extended from the board and therefore, the connection is executed while exerting an elastic force of the spring, and wiring of the electromagnetic relay system can further be simplified.

According to the fourth aspect of the present invention, wiring of the multiple connected type electromagnetic relay can be simplified and waterproof performance of the electromagnetic relay system can be promoted.

### BRIEF DESCRIPTION OF THE DRAWINGS

FIG. 1 is a top view showing an electromagnetic relay system according to an embodiment of the invention.

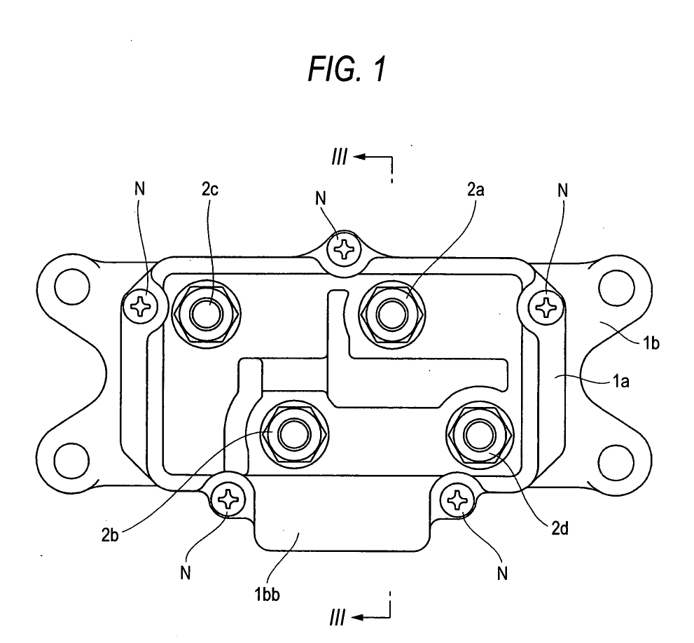

FIG. 2 is a front view showing the electromagnetic relay system.

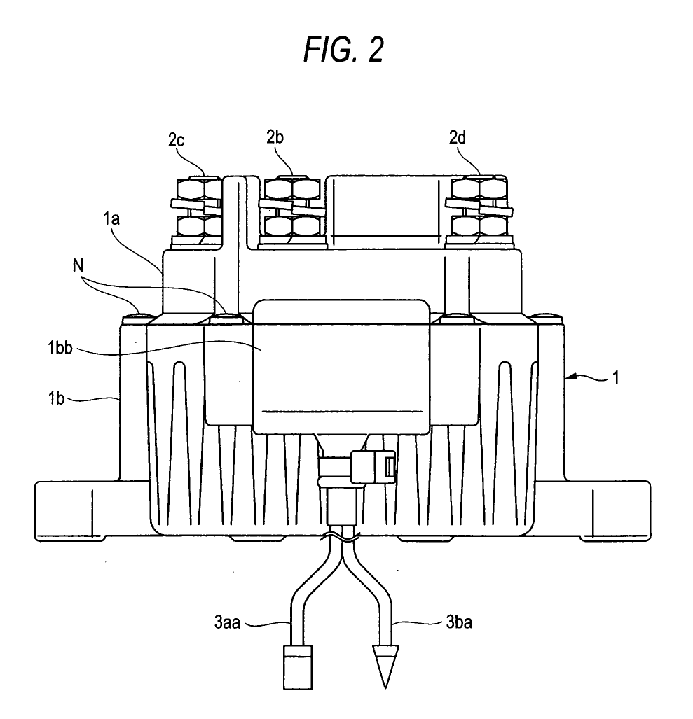

FIG. 3 is a sectional view taken along a line III-III in FIG. 1.

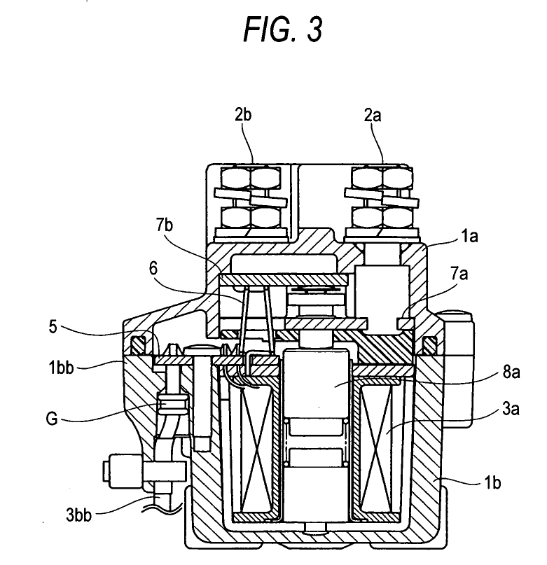

FIG. 4 is a wiring diagram showing the electromagnetic relay system according to the embodiment of the invention.

FIG. 5 is a wiring diagram showing operating means applied to the electromagnetic relay system.

### DESCRIPTION OF THE PREFERRED EMBODIMENTS

A detailed explanation will be given of an embodiment of the invention in reference to the drawings as follows.

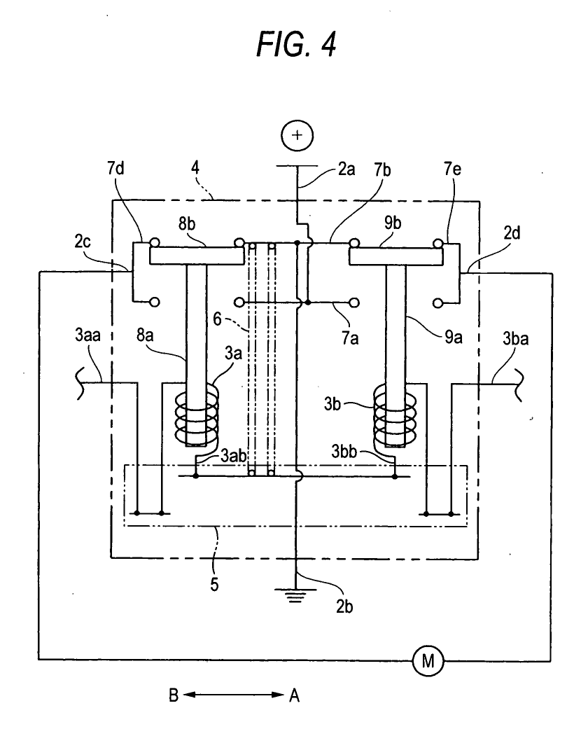

In an electromagnetic relay system according to the embodiment, a motor for driving a winch mounted on an ATV (All Terrain Vehicle) is selectively rotated in a regular direction or a reverse direction. The electromagnetic relay system is essentially constituted by a case 1 comprising a lid 1a and a cabinet 1b, an electromagnetic relay 4 comprising a plurality of terminals 2a through 2d formed to project upward from the lid 1a of the case 1, coils 3a, 3b (refer to FIG. 4) and a plurality of fixed contacts, aboard 5 arranged at a vicinity of an opening portion of the cabinet 1b, and a coil spring 6 made of a conductive material of copper, phosphor bronze or the like.

Inside of the cabinet 1b of the case 1 is contained with the coils 3a, 3b, movable contacts 8b, 9b and a plurality of fixed terminals 7a, 7b, 7d, 7e, the board 5 and the coil spring 6. The terminals 2a and 2b constitute a positive terminal and a negative terminal respectively connectable to a positive pole and a negative pole of a battery (not illustrated) constituting a power source. The terminals 2c and 2d constitute terminals for a load which can respectively be connected to a motor M as the load. Further, the cabinet 1b is attached with the lid 1a after containing the above-described various constituent elements at inside of the cabinet 1b. The lid 1a and the cabinet 1b are fixed by a plurality of screws N. An inside of the case 1 is constituted by a hermetically closed structure.

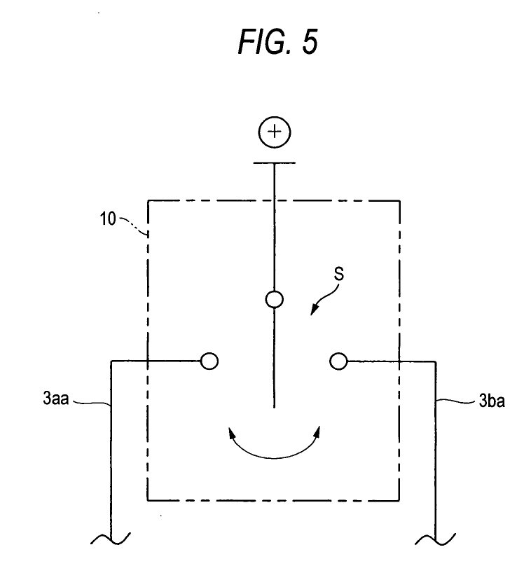

Further, as shown in FIG. 4, a base end of the positive terminal 2a is connected to the fixed contact 7a, a base end of the negative terminal 2b is connected to the fixed contact 7b, and the fixed contact 7b of the fixed contacts is connected to the board 5 via the coil spring 6. The coils 3a and 3b are constituted by connecting both ends thereof to a pair of control wirings 3aa and 3ba extended from operating means 10 shown in FIG. 5 and to ground lines 3ab and 3bb. By operating a switch S of the operating means 10, it is possible to arbitrarily select whether an electric current is made to flow to the coil 3a via the control wiring 3aa or whether an electric current is made to flow to the coil 3b via the control wiring 3ba.

Further, the cabinet 1b is formed with a bulged portion 1bb. The bulged portion 1bb is formed with an opening directed to a lower side of the electromagnetic relay system. The control wirings 3aa and 3ba are inserted from the opening and connected to predetermined portions of the board 5. That is, the control wirings 3aa and 3ba are electrically connected to respectives of the coils 3a and 3b via the board 5. Further, notation G in the drawing designates a seal member for filling to seal gaps between the opening of the bulged portion 1bb and the control wirings 3aa and 3ba.

Meanwhile, a print wiring is printed on the board 5. The ground lines 3ab, 3bb extended from the coils 3a and 3b are connected to the print wiring and further connected the fixed contact 7b via the coil spring 6. Thereby, an electric current flowed in the board 5 reaches to the negative terminal 2b via the fixed contact 7b.

Further, the coils 3a and 3b are respectively inserted with iron cores 8a and 9a, and when the iron core 8a or 9a is operated by a magnetic field generated by an electric current flowed to the coil 3a or 3b, the movable contact 8b or 9b provided at a front end of the iron core 8a or 9a is constituted to move from a position spanning the fixed contact 7b and the fixed contact 7d or 7e to a position spanning the fixed contact 7a and the fixed contact 7d or 7e.

That is, when the switch S of the operating means 10 is moved to the left side in FIG. 5, the electric current is made to flow to the coil 3a, and therefore, the iron core 8a is moved to the lower side in FIG. 4 by the magnetic field generated by the coil 3a and the movable contact 8b is disposed at a position of spanning the fixed contacts 7a and 7d. Thereby, the electric current from the positive terminal 2a flows in a direction directed to the load terminal 2d from the load terminal 2c (“A” direction in the drawing), and the motor M is driven to regularly rotate. Further, the electric current reaching to the load terminal 2d reaches to the fixed contact 7b via the movable contact 9b provided at the front end of the iron core 9a and flows to the negative terminal 2b.

Meanwhile, when the switch S of the operating means 10 is moved to the right side of FIG. 5, the electric current flows to the coil 3b and therefore, the iron core 9a is moved to the lower side in FIG. 4 by the magnetic field generated by the coil 3b, and the movable contact 9b provided at the front end is disposed at the position spanning the fixed contacts 7a and 7e. Thereby, the electric current from the positive side terminal 2a flows in a direction directed to the load terminal 2c from the load terminal 2d (“B” direction in the drawing) and the motor M is driven to reversely rotate. Further, the electric current reaching to the load terminal 2c reaches to the fixed contact 7b via the fixed contact 7d, and the movable contact 8b provided at the front end of the iron core 8a and flows to the negative terminal 2b.

Here, according to the embodiment, the ground lines 3ab and 3bb extended from the coils 3a and 3b are connected to the negative terminal 2b at inside of the case 1 and therefore, the waterproof performance can be improved in comparison with the constitution of arranging the ground line at the external portion as in the related art.

Further, the electromagnetic relay 4 according to the invention is a multiple connected electromagnetic relay arranged with a plurality (specifically, two) of the coils at inside of the case 1, the board 5 is arranged at inside of the case 1, the respective ground lines 3ab and 3bb extended from the respective coils 3a and 3b are connected to the negative terminal 2b via the board 5 and therefore, wiring can be simplified and operability in fabricating the electromagnetic relay system can be promoted.

Further, the coil spring 6 made of the conductive material is interposed between the board 5 and the negative side terminal 2b, the ground lines 3ab and 3bb are connected to the negative terminal 2b via the coil spring 6 and therefore, the connection is executed while exerting an elastic force of the coil spring 6 and the wiring of the electromagnetic relay system can further be simplified. That is, in integrating the lid 1a to cover the cabinet 1b, the coil spring 6 projected upward from the board 5 is projected to the fixed contact 7b arranged on the side of the lid 1a to produce the elastic force and therefore, the both members can electrically be connected in a state of being exerted with the predetermined press contact force.

Although an explanation has be given of the embodiment as described above, the invention is not limited thereto but may be applied to, for example, a constitution of containing a single one of the coil in the case, or a constitution containing three or more of the coils in the case so far as the electromagnetic relay is arranged in the case, and the ground line extended from the coil is connected to the negative terminal in the case. Further, the ground line extended from the coil constituting the electromagnetic relay may be connected to the negative terminal in the case without interposing the board.

Further, although according to the embodiment, the spring interposed between the board and the negative terminal is constituted by the coil spring, the coil may be constituted by other spring (leaf spring or the like) so far as the spring is a spring comprising the conductive material. Furthermore, although the electromagnetic relay system according to the embodiment is applied as an apparatus of switching to rotate regularly and rotate reversely the motor for driving the winch provided to the ATV, the electromagnetic relay system can be applied also as an electromagnetic relay system of other load of, for example, driving means for tilting an outboard motor or the like.

Further, the present invention is applicable to a constitution having a different outlook shape or a constitution added with other function so far as the constitution is an electromagnetic relay system in which a ground line extended from a coil is connected to a negative terminal at inside of a case.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. An electromagnetic relay system comprising:
an electromagnetic relay arranged in a case and including a coil, a movable contact and a plurality of fixed contacts;
a positive terminal formed to project from the case and connectable to a power source at a positive pole side;
a negative terminal formed to project from the case and connectable to the power source at a negative pole side;
a load terminal formed to project from the case and connectable to a load, wherein an electric current in the load is controlled by controlling an electric current in the coil; and
a ground line extended from the coil and connected to the negative terminal in the case.

2. The electromagnetic relay system according to claim 1, further comprising:
a board arranged in the case,
wherein the ground line is connected to the negative terminal via the board.

3. The electromagnetic relay system according to claim 2, further comprising:
a spring comprising a conductive material and interposed between the board and the negative terminal,
wherein the ground line is connected to the negative terminal via the spring.

4. The electromagnetic relay system according to claim 1, wherein the electromagnetic relay comprises a multiple connected type electromagnetic relay arranged with a plurality of the coils in the case.

5. The electromagnetic relay system according to claim 2, wherein the electromagnetic relay comprises a multiple connected type electromagnetic relay arranged with a plurality of the coils in the case.

6. The electromagnetic relay system according to claim 3, wherein the electromagnetic relay comprises a multiple connected type electromagnetic relay arranged with a plurality of the coils in the case.
